(19) United States
(12) Patent Application Publication
(10) Pub. No.: US 2022/0300758 A1
(43) Pub. Date: Sep. 22, 2022

(54) DEVICE AND IN PARTICULAR COMPUTER-IMPLEMENTED METHOD FOR DETERMINING A SIMILARITY BETWEEN DATA SETS

(71) Applicant: Robert Bosch GmbH, Stuttgart (DE)

(72) Inventors: Lukas Lange, Pforzheim (DE); Heike Adel-Vu, Renningen (DE); Jannik Stroetgen, Karlsruhe (DE)

(21) Appl. No.: 17/654,430

(22) Filed: Mar. 11, 2022

(30) Foreign Application Priority Data
Mar. 16, 2021 (DE) 10 2021 202 566.8

(51) Int. Cl. G06K 9/62

(52) U.S. Cl. CPC G06K 9/6252; G06K 9/6215; G06K 9/6256; G06K 9/6269

(57) ABSTRACT

A device and a computer-implemented method, for determining a similarity between data sets. A first data set that includes a plurality of first embeddings, and a second data set that includes a plurality of second embeddings, are predefined. A first model is trained on the first data set, and a second model is trained on the second data set. A set of first features of the first model is determined on the second data set, which for each second embedding includes a feature of the first model, and a set of second features of the second model is determined on the second data set, which for each second embedding includes a feature of the second model. A map that optimally maps the set of first features onto the set of second features is determined. The similarity is determined as a function of a distance of the map from a reference.

### CROSS REFERENCE

The present application claims the benefit under 35 U.S.C. § 119 of German Patent Application No. DE 10 2021 202 566.8 filed on Mar. 16, 2021, which is expressly incorporated herein by reference in its entirety.

### FIELD

The present invention is directed to a device and an in particular computer-implemented method for determining a similarity between data sets, in particular images.

### SUMMARY

In accordance with an example embodiment of the present invention, a method, in particular a computer-implemented method, for determining a similarity of data sets provides that a first data set that includes a plurality of first embeddings is predefined, a second data set that includes a plurality of second embeddings being predefined, a first model being trained on the first data set, a second model being trained on the second data set, a set of first features of the first model being determined on the second data set, which for each second embedding includes a feature of the first model, a set of second features of the second model being determined on the second data set, which for each second embedding includes a feature of the second model, a map being determined that optimally maps the set of first features onto the set of second features, the similarity being determined as a function of a distance of the map from a reference. The method is applicable using models that provide feature representations, regardless of a particular model architecture. A similarity of the data sets may thus be detected significantly better.

The first embeddings of the plurality of first embeddings each preferably represent a digital image from a plurality of first digital images, the second embeddings of the plurality of second embeddings each representing a digital image from a plurality of second digital images. In this way, two data sets that contain digital images and whose contents are particularly similar to one another may be found.

The first embeddings of the plurality of first embeddings each preferably represent a portion of a first corpus, the second embeddings of the plurality of second embeddings each representing a portion of a second corpus. In this way, two corpora whose contents are particularly similar to one another may be found.

In accordance with an example embodiment of the present invention, it may be provided that the first model includes an artificial neural network with an input layer and an output layer, for each second embedding situated at the input layer of the first model, an output of a layer, in particular a last layer prior to the output layer, between the input layer and the output layer being determined that characterizes a feature associated with the second embedding, and/or that the second model includes an artificial neural network with an input layer and an output layer, for each second embedding situated at the input layer of the second model, an output of a layer, in particular a last layer prior to the output layer, between the input layer and the output layer being determined that characterizes a feature associated with the second embedding.

In accordance with an example embodiment of the present invention, it is preferably provided that the artificial neural networks having the same architecture, in particular an architecture of a classifier, are predefined, or that the layers whose output characterizes the features have the same dimensions.

In accordance with an example embodiment of the present invention, it may be provided that for a training, a training data set is determined that includes the first data set or a portion thereof when the similarity of the first data set to the second data set is greater than a similarity of a third data set to the second data set, and that otherwise the training data set is determined as a function of the third data set, in a training the second model being pretrained with data of the training data set and then being trained with data of the second data set. In this way, the second model is pretrained on data from a data set having a particularly great similarity to the second data set.

The in particular best possible data set for the pretraining is preferably selected by selecting the data set having a minimum distance from the second data set.

The map is preferably determined as a function of distances of each first feature from each second feature, in particular with the aid of a Procrustean method that minimizes these distances.

The similarity is preferably determined as a function of a norm of the distance of the map from the reference.

In one aspect of the present invention, it is provided that the second model is trained or becomes trained for a classification of embeddings, at least one embedding of a digital image or of a portion of a corpus being detected or received, and the embedding being classified by the second model.

In accordance with an example embodiment of the present invention, a device for determining a similarity of data sets is designed to carry out the method.

In accordance with an example embodiment of the present invention, a computer program that includes computer-readable instructions is likewise provided, the method running when the computer-readable instructions are executed by a computer.

Further advantageous specific embodiments result from the following description and the figures.

### BRIEF DESCRIPTION OF THE DRAWINGS

FIG. 1 shows a schematic illustration of portions of a device for determining a similarity of data sets, in accordance with an example embodiment of the present invention.

FIG. 2 shows steps in a method for determining a similarity of data sets, in accordance with an example embodiment of the present invention.

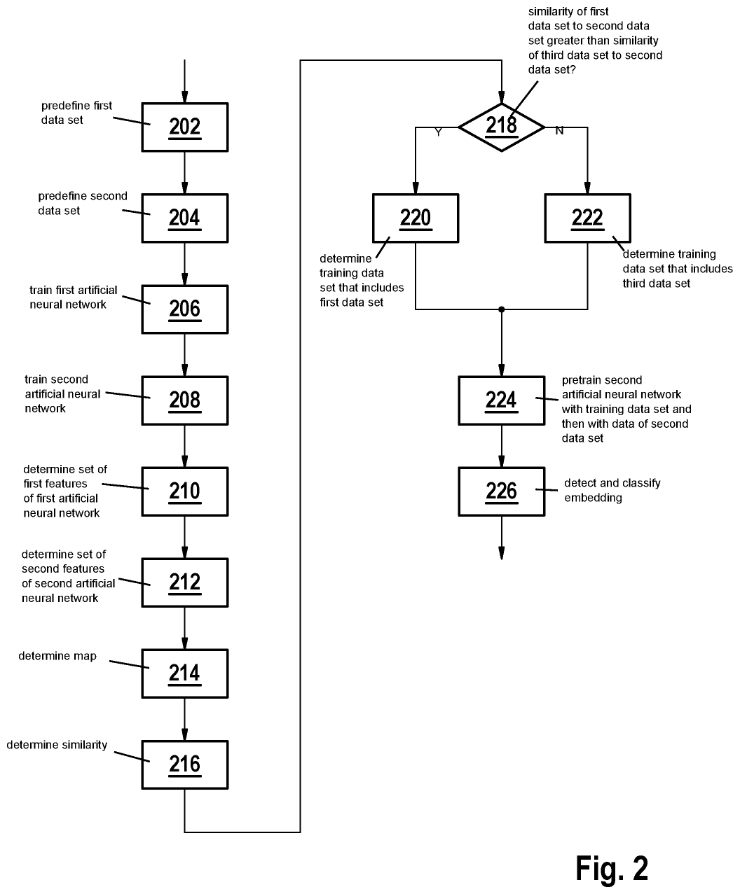

### DETAILED DESCRIPTION OF EXAMPLE EMBODIMENTS

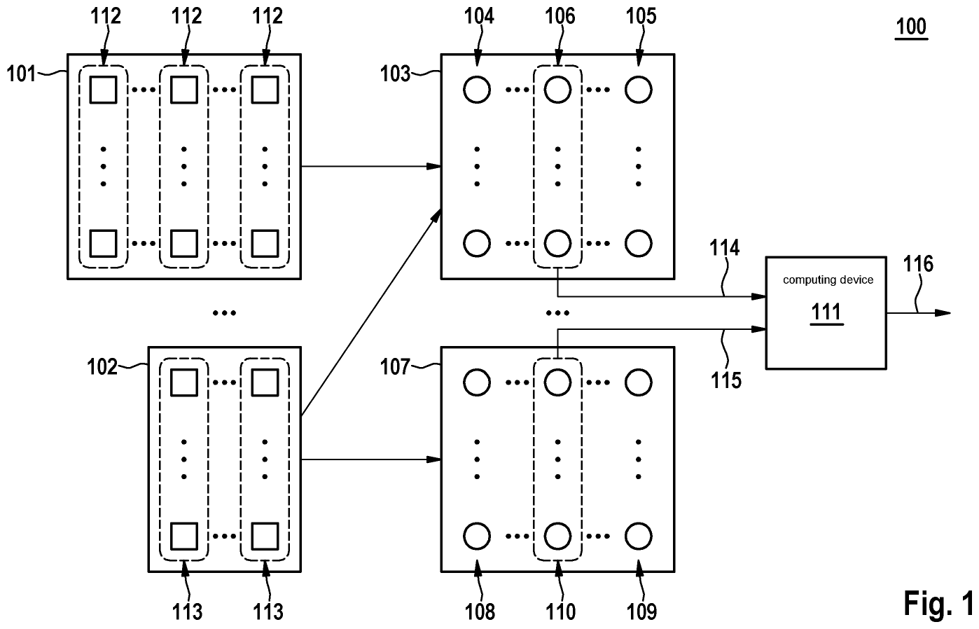

FIG. 1 shows a schematic illustration of portions of a device 100 for determining a similarity of data sets. This is described below with reference to a first data set 101 and a second data set 102. In the example, the data sets are digital representations, in particular numeric or alphanumeric representations, of images, metadata of images, or portions of corpora. In the example, second data set 102 is a target data set on which a model for solving a task is to be trained. In the example, first data set 101 is a candidate for a training data set on which the model is to be pretrained, if the first data set proves to be suitable for this purpose.

Device 100 is designed to establish a similarity of data sets to second data set 102. This is described by way of example for the similarity between first data set 101 and second data set 102.

Device 100 includes a plurality of models. FIG. 1 schematically illustrates a first model and a second model. Device 100 is designed to determine, using the first model and the second model, a similarity of first data set 101 to second data set 102.

Device 100 may include a third model via which a similarity of a third data set to second data set 102 is determined. Device 100 may include an arbitrary number of further models for other data sets.

In the example, the first model is a first artificial neural network 103 that includes an input layer 104 and an output layer 105, as well as a layer 106 situated between input layer 104 and output layer 105.

In the example, the second model is a second artificial neural network 107 that includes an input layer 108 and an output layer 109, as well as a layer 110 situated between input layer 108 and output layer 109.

The artificial neural networks may be classifiers. In the example, the artificial neural networks have the same architecture. The architectures do not have to be identical.

Device 100 includes a computing device 111. Computing device 111 is designed to train the models with the particular data sets. Computing device 111 is designed, for example, to train the first model with embeddings 112 from first data set 101. Computing device 111 is designed, for example, to train the second model with embeddings 113 from second data set 102.

Computing device 111 is designed to extract features 114 from layer 106. Computing device 111 is designed to extract features 115 from layer 110. In the example, layers 106, 110 whose output characterizes features 114, 115 have the same dimensions. The dimensions do not have to be identical.

Computing device 111 is designed to select a data set, from the plurality of data sets, that has a greater similarity to second data set 102 than some other data set or than all other data sets from the plurality of data sets. In the example, for this purpose computing device 111 is designed to carry out the method described below.

Computing device 111 is designed, for example, to determine a selected data set 116 as a function of features 114, 115 that are extracted from layers 106, 110.

Computing device 111 is designed, for example, in a training to train the second model initially with selected data set 116, and subsequently with second data set 102.

In one example, the second model is to be trained for a task with second data set 102. In the example, there are only few training data for second data set 102. In contrast, in the example there are more training data for first data set 101 and other data sets from the plurality of data sets.

By use of the method described below, it is determined which of the data sets from the plurality of data sets is closest to second data set 102 and is suitable for pretraining the second model. The second model is pretrained with the data set thus determined, and then trained with second data set 102. In this way, better performance is achieved than is to be expected from training the second model only with second data set 102.

This is described using first data set 101 and second data set 102 as well as the third data set as an example. The method is correspondingly applicable to the plurality of data sets.

Instead of using one of the mentioned data sets, it is also possible to use only a portion, in particular a randomly selected portion, of the data sets.

The method may be applied for various data sets. The first embeddings 112, for example, may each represent one digital image from a plurality of first digital images. The second embeddings 113, for example, may each represent one digital image from a plurality of second digital images. These embeddings may each numerically represent pixels of an image, for example the red, green, and blue components of the image.

First embeddings 112 may each numerically represent a portion of a first corpus, for example a word, a portion of a word, or a portion of a set. Second embeddings 113 may each numerically represent a portion of a second corpus, for example a word, a portion of a word, or a portion of a set.

In the method, a first data set 101 that includes a plurality of first embeddings 112 is predefined in a step 202.

In the method, a second data set 102 that includes a plurality of second embeddings 113 is predefined in a step 204.

First artificial neural network 103 is trained on first data set 101 in a step 206.

Second artificial neural network 107 is trained on second data set 102 in a step 208.

In the example, the artificial neural networks are trained for classification. In the example, training is carried out with supervision. In the example, the training data include labels that associate with the individual embeddings one of the classes into which the particular artificial neural network may classify the embedding. Digital images in the training data may be classified, for example, according to an object or subject that represents them. Corpora may be classified, for example, according to names the corpora include.

These steps may be carried out in succession or essentially in parallel with one another with regard to time.

A set of first features 114 of first artificial neural network 103 on second data set 102 is subsequently determined in a step 210. In the example, for each embedding 113 of second data set 102 a feature 114 of first artificial neural network 103 is determined and added to the set of first features 114. Feature 114 is an output of layer 106 onto which first artificial neural network 103 maps embedding 113 at input layer 104.

A set of second features 115 of second artificial neural network 107 on second data set 102 is determined in a step 212. In the example, for each second embedding 113 of second data set 102 a feature 115 of second artificial neural network 107 is determined and added to the set of second features 115. Steps 212 may be carried out in succession or essentially in parallel with one another with regard to time. Feature 115 is an output of layer 110 onto which second artificial neural network 107 maps embedding 113 at input layer 108.

A map MP that optimally maps the set of first features 114 onto the set of second features 115 is determined in a step 214.

In the example, a first feature 114 from the set of first features 114 is a vector F1(v) for a particular embedding v. In the example, a second feature 115 from the set of second features 115 is a vector F2(v) for particular embedding v. In the example, the embeddings are likewise vectors. In one example, map MP is conditionally defined by a matrix M having the dimensions of the features:

MP: F2(v)≈M F1(v).

In the example, map MP is determined in such a way that features F1 according to the map are very similar to features F2. In the example, this map is determined with the aid of the Procrustean method, in that a matrix M including the pointwise distances of the vectors is minimized by shifting, scaling, and rotating of the features:

$${M}_{M 1 , M 2}^{2} = {\sum }_{x} F 1 {( v )}_{x} - F 2 {( v )}_{x}$$

Map MP may also be computed in some other way.

The similarity is subsequently determined in a step 216 as a function of a distance of map MP from a reference.

In the example, the map is compared to a unit matrix I as reference, with the aid of a matrix norm. The distance between the models is determined, for example, from the difference between M_{M1,M2}² and unit matrix I. In the example, a great deviation is interpreted as a large distance between the models, and therefore between the data sets with which these models have been trained.

Steps 202 through 216 may be carried out for the comparison of a plurality of other data sets to second data set 102. In the example, these steps are carried out at least for a third data set.

It is subsequently checked in a step 218 whether a similarity of first data set 101 to second data set 102 is greater than a similarity of the third data set to second data set 102. If the similarity of first data set 101 to second data set 102 is greater, a step 220 is carried out. Otherwise, a step 222 is carried out.

A training data set that includes first data set 101 or a portion thereof is determined in step 220. Step 224 is subsequently carried out.

A training data set that includes the third data set or a portion thereof is determined in step 222. Step 224 is subsequently carried out.

In a training with data of the training data set, second artificial neural network 107 is pretrained and then trained with data of second data set 102 in step 224.

In the example, a step 226 is subsequently carried out.

At least one embedding is detected or predefined, and classified using second artificial neural network 107 thus trained, in step 226.

The embedding is a function of what has been trained for, an embedding of a digital image or a portion of a corpus.

What is claimed is:

1. A computer-implemented method for determining a similarity of data sets, comprising the following steps:
predefining a first data set that includes a plurality of first embeddings;
predefining a second data set that includes a plurality of second embeddings;
training a first model on the first data set;
training a second model on the second data set;
determining a set of first features of the first model on the second data set, which for each of the second embeddings, includes a feature of the first model;
determining a set of second features of the second model on the second data set, which for each of the second embeddings includes a feature of the second model;
determining a map that optimally maps the set of first features onto the set of second features; and
determining a similarity as a function of a distance of the map from a reference.

2. The method as recited in claim 1, wherein each first embedding of the plurality of first embeddings represents a digital image from a plurality of first digital images, each second embedding of the plurality of second embeddings represents a digital image from a plurality of second digital images.

3. The method as recited in claim 1, wherein each first embedding of the plurality of first embeddings represents a portion of a first corpus, and each second embedding of the plurality of second embeddings represents a portion of a second corpus.

4. The method as recited in claim 1, wherein the first model includes an artificial neural network with an input layer and an output layer, for each second embedding situated at the input layer of the first model, a last layer prior to the output layer, between the input layer and the output layer, being determined that characterizes a feature associated with the second embedding, and/or the second model includes an artificial neural network with an input layer and an output layer, for each second embedding situated at the input layer of the second model, a last layer prior to the output layer, between the input layer and the output layer, being determined that characterizes a feature associated with the second embedding.

5. The method as recited in claim 4, wherein the artificial neural networks have the same architecture of an architecture of a classifier, or have layers whose output characterizes the features have the same dimensions.

6. The method as recited in claim 1, wherein a training data set is determined that includes the first data set or a portion of the first data set, when the similarity of the first data set to the second data set is greater than a similarity of a third data set to the second data set, and otherwise the training data set is determined as a function of the third data set, and wherein, in a training, the second model is pretrained with data of the training data set and then being trained with data of the second data set.

7. The method as recited in claim 1, wherein the map is determined as a function of distances of each first feature from each second feature, using a Procrustean method that minimizes the distances.

8. The method as recited in claim 1, wherein the similarity is determined as a function of a norm of the distance of the map from the reference.

9. The method as recited in claim 1, wherein the second model is trained or becomes trained for a classification of embeddings, at least one embedding of a digital image or of a portion of a corpus being detected or received, and the embedding being classified by the second model.

10. A device configured to determine a similarity of digital data sets, the device configured to:
predefine a first data set that includes a plurality of first embeddings;
predefine a second data set that includes a plurality of second embeddings;
train a first model on the first data set;
train a second model on the second data set;
determining a set of first features of the first model on the second data set, which for each of the second embeddings, includes a feature of the first model;
determine a set of second features of the second model on the second data set, which for each of the second embeddings includes a feature of the second model;
determine a map that optimally maps the set of first features onto the set of second features; and
determine a similarity as a function of a distance of the map from a reference.

11. A non-transitory computer-readable medium on which is stored a computer program including computer-readable instructions for determining a similarity of digital data sets, the instructions, when executed by a computer, causing the computer to perform the following steps:
predefining a first data set that includes a plurality of first embeddings;
predefining a second data set that includes a plurality of second embeddings;
training a first model on the first data set;
training a second model on the second data set;
determining a set of first features of the first model on the second data set, which for each of the second embeddings, includes a feature of the first model;
determining a set of second features of the second model on the second data set, which for each of the second embeddings includes a feature of the second model;
determining a map that optimally maps the set of first features onto the set of second features; and
determining a similarity as a function of a distance of the map from a reference.
